(19) United States
(12) Patent Application Publication
(10) Pub. No.: US 2026/0121070 A1
(43) Pub. Date: Apr. 30, 2026

(54) THREE-DIMENSIONAL COMPOSITE COPPER FOIL FOR SOLID-STATE LITHIUM BATTERY AND PREPARATION METHOD THEREFOR

(71) Applicant: Shenzhen Baoming Technology Co., Ltd., Shenzhen (CN)

(72) Inventor: Jun LI, Shenzhen (CN)

(73) Assignee: Shenzhen Baoming Technology Co., Ltd., Shenzhen (CN)

(21) Appl. No.: 19/366,431

(22) Filed: Oct. 22, 2025

(30) Foreign Application Priority Data
Oct. 24, 2024 (CN) 202411494186.0

(51) Int. Cl. H01M 4/66; H01M 4/04

(52) U.S. Cl. CPC H01M 4/661; H01M 4/0404; H01M 4/0426; H01M 4/045; H01M 4/667; H01M 4/668

(57) ABSTRACT

Disclosed are a three-dimensional composite copper foil for a solid-state lithium battery and a preparation method therefor. The three-dimensional composite copper foil for the solid-state lithium battery includes a support layer, the support layer is a porous membrane layer or a fibrous membrane layer, a first metallization layer and a second metallization layer are arranged on two faces of the support layer, respectively, a third metallization layer is arranged on one face of the first metallization layer away from the support layer, a fourth metallization layer is arranged on one face of the second metallization layer away from the support layer, a first conductive copper layer is arranged on one face of the third metallization layer away from the first metallization layer, and a second conductive copper layer is arranged on one face of the fourth metallization layer away from the second metallization layer.

### CROSS-REFERENCE TO RELATED APPLICATIONS

This application claims priority to Chinese Patent Application No. 202411494186.0, filed on Oct. 24, 2024, the content of which is incorporated herein by reference in its entirety.

### TECHNICAL FIELD

The present application relates to the technical field of battery production, and specifically relates to three-dimensional composite copper foil for a solid-state lithium battery and a preparation method therefor.

### BACKGROUND

Existing solid-state lithium batteries generally adopt copper foil as a negative current collector. Since the copper foil is generally solid copper with a large weight and a copper material has a lager use amount and a high cost, the weight of the solid-state lithium batteries is larger, and the manufacturing cost of the solid-state lithium batteries is increased. Meanwhile, during a charge-discharge process of the solid-state lithium batteries, since a pore allowing lithium ions in an electrolyte to pass through is not arranged on the copper foil, the lithium ions in the electrolyte move from one side of the copper foil to the other side of the copper foil at a relatively low speed, thereby reducing the charge-discharge speed of the solid-state lithium batteries.

### SUMMARY

To overcome the shortcomings of the prior art, the present application provides three-dimensional composite copper foil for a solid-state lithium battery and a preparation method therefor, which can reduce the weight and manufacturing cost of the solid-state lithium battery, and meanwhile can increase the charge-discharge speed of the solid-state lithium battery.

Technical solutions adopted by the present application to solve the technical problems are as follows.

A first aspect of the present application provides three-dimensional composite copper foil for a solid-state lithium battery, which includes a support layer, the support layer is a porous membrane layer or a fibrous membrane layer, a first metallization layer and a second metallization layer are arranged on two faces of the support layer, respectively, a third metallization layer is arranged on one face of the first metallization layer away from the support layer, a fourth metallization layer is arranged on one face of the second metallization layer away from the support layer, a first conductive copper layer is arranged on one face of the third metallization layer away from the first metallization layer, and a second conductive copper layer is arranged on one face of the fourth metallization layer away from the second metallization layer.

As a preferred technical solution, the porous membrane layer is a polyethylene terephthalate (PET) porous membrane layer, a polypropylene (PP) porous membrane layer, a polyimide (PI) porous membrane layer, or a PE porous membrane layer.

As a preferred technical solution, the fibrous membrane layer is a PET fibrous membrane layer, a PP fibrous membrane layer, a PI fibrous membrane layer, or a PE fibrous membrane layer.

As a preferred technical solution, a pore of the porous membrane layer or the fibrous membrane layer has a pore size of 0.05-500 μm and a porosity of 0.1%-80%.

As a preferred technical solution, materials of the first metallization layer and the second metallization layer are both a combination of one or more of cobalt, aluminum, nickel, cadmium, magnesium, lithium, and manganese.

As a preferred technical solution, materials of the third metallization layer and the fourth metallization layer are both copper or a copper alloy.

As a preferred technical solution, a thickness of the support layer is 1-30 μm.

As a preferred technical solution, thicknesses of the first metallization layer and the second metallization layer are both 5-100 nm, and thicknesses of the third metallization layer and the fourth metallization layer are both 10-200 nm.

As a preferred technical solution, thicknesses of the first conductive copper layer and the second conductive copper layer are both 500-2,000 nm.

A second aspect of the present application provides a method for preparing three-dimensional composite copper foil for a solid-state lithium battery, which includes the following steps:
S1, providing a support layer, wherein the support layer is a porous membrane layer or a fibrous membrane layer;
S2, arranging a first metallization layer and a second metallization layer on two faces of the support layer by a method of magnetron sputtering, evaporation or chemical plating, respectively;
S3, arranging a third metallization layer on one face of the first metallization layer away from the support layer and arranging a fourth metallization layer on one face of the second metallization layer away from the support layer by a method of magnetron sputtering, evaporation or chemical plating; and
S4, arranging a first conductive copper layer on one face of the third metallization layer away from the first metallization layer and arranging a second conductive copper layer on one face of the fourth metallization layer away from the second metallization layer by a method of electroplating or evaporation.

Beneficial effects of the present application are as follows. According to the present application, through arrangement of the support layer, the support layer as the porous membrane layer or the fibrous membrane layer can reduce the weight of the composite copper foil and reduce the use amount of a copper material, thereby reducing the weight and manufacturing cost of the solid-state lithium battery. Moreover, during a charge-discharge process of the solid-state lithium battery, the pore on the porous membrane layer or the pore on the fibrous membrane layer can serve as a channel for lithium ions in an electrolyte to move, so that the lithium ions in the electrolyte of the solid-state lithium battery can quickly move from one side of the composite copper foil to the other side of the composite copper foil, thereby increasing the charge-discharge speed of the solid-state lithium battery. Through arrangement of the first conductive copper layer and the second conductive copper layer, requirements for current carrying performance and tensile strength of the composite copper foil can be met, thereby meeting requirements for performance of the solid-state lithium battery. In addition, the arranged first metallization layer plays a role of isolating the first conductive copper layer and the support layer, and the arranged second metallization layer plays a role of isolating the second conductive copper layer and the support layer, thereby achieving a protective effect on the support layer. During a high and low temperature cycle test of the solid-state lithium battery, a situation that the support layer is ironed can be avoided, thereby improving the stability of the composite copper foil during the high and low temperature cycle test of the solid-state lithium battery. Through arrangement of the third metallization layer and the fourth metallization layer, a bonding force between the first metallization layer and the first conductive copper layer and a bonding force between the second metallization layer and the second conductive copper layer can be improved, and falling of the first conductive copper layer and the second conductive copper layer can be avoided.

### BRIEF DESCRIPTION OF THE DRAWINGS

The present application is further described below in conjunction with accompanying drawings and embodiments.

FIG. 1 is a structural schematic diagram of three-dimensional composite copper foil for a solid-state lithium battery provided in an embodiment of the present application.

FIG. 2 is a flowchart diagram of a method for preparing three-dimensional composite copper foil for a solid-state lithium battery provided based on the three-dimensional composite copper foil for the solid-state lithium battery shown in FIG. 1.

### DETAILED DESCRIPTION OF THE EMBODIMENTS

The concepts, specific structure and resulting technical effects of the present application are clearly and completely described below in conjunction with embodiments and accompanying drawings to make objectives, features and effects of the present application fully understood. Obviously, the described embodiments are only a part of the embodiments of the present application, rather than all of the embodiments. Based on the embodiments of the present application, all other embodiments obtained by those skilled in the art without exerting creative efforts fall within the scope of protection of the present application. In addition, all linking/connection relationships referred to in the patent do not simply refer to direct connection of components, but refer to addition or reduction of linking accessories to form better linking structures according to specific implementations. Various technical features in the inventive creation can be combined interchangeably under the premise of not conflicting with each other.

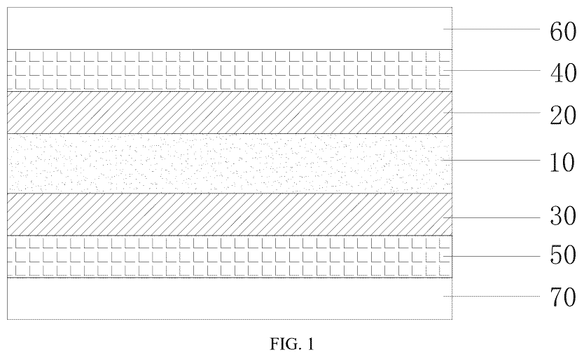

Referring to FIG. 1, a three-dimensional composite copper foil for a solid-state lithium battery provided in an embodiment of the present application includes a support layer 10, wherein the support layer 10 is a porous membrane layer or a fibrous membrane layer. A first metallization layer 20 and a second metallization layer 30 are arranged on two faces of the support layer 10, respectively. A third metallization layer 40 is arranged on one face of the first metallization layer 20 away from the support layer 10. A fourth metallization layer 50 is arranged on one face of the second metallization layer 30 away from the support layer 10. A first conductive copper layer 60 is arranged on one face of the third metallization layer 40 away from the first metallization layer 20. A second conductive copper layer 70 is arranged on one face of the fourth metallization layer 50 away from the second metallization layer 30.

According to the composite copper foil of the present application with the above structure, the support layer 10 as the porous membrane layer or the fibrous membrane layer plays a role of supporting the entire composite copper foil and has characteristics of light weight, low cost and good ductility, which can reduce the weight of the composite copper foil and reduce the use amount of a copper material, thereby reducing the weight and manufacturing cost of the solid-state lithium battery. Meanwhile, the ductility of the composite copper foil can be improved, and a situation of damage or fracture caused by expansion or contraction of an electrolyte during a charge-discharge process of the solid-state lithium battery can be avoided. Moreover, during the charge-discharge process of the solid-state lithium battery, a pore on the porous membrane layer or a pore on the fibrous membrane layer can serve as a channel for lithium ions in the electrolyte to move, so that the lithium ions in the electrolyte of the solid-state lithium battery can quickly move from one side of the composite copper foil to the other side of the composite copper foil, thereby increasing the charge-discharge speed of the solid-state lithium battery. The arranged first conductive copper layer 60 and the second conductive copper layer 70 have good conductivity, which can meet requirements for current carrying performance and tensile strength of the composite copper foil, thereby meeting requirements for performance of the solid-state lithium battery. The arranged first metallization layer 20 plays a role of isolating the first conductive copper layer 60 and the support layer 10, and the arranged second metallization layer 30 plays a role of isolating the second conductive copper layer 70 and the support layer 10, thereby achieving a protective effect on the support layer 10. During a high and low temperature cycle test of the solid-state lithium battery, a situation that the support layer 10 is ironed can be avoided, thereby improving the stability of the composite copper foil during the high and low temperature cycle test of the solid-state lithium battery. The arranged third metallization layer 40 can improve a bonding force between the first metallization layer 20 and the first conductive copper layer 60 and avoid falling of the first conductive copper layer 60. The arranged fourth metallization layer 50 can improve a bonding force between the second metallization layer 30 and the second conductive copper layer 70 and avoid falling of the second conductive copper layer 70.

In the present embodiment, the first metallization layer 20 and the second metallization layer 30 are arranged on the two faces of the support layer 10 by a method of magnetron sputtering, evaporation or chemical plating, respectively, the third metallization layer 40 is arranged on the face of the first metallization layer 20 away from the support layer 10 by a method of magnetron sputtering, evaporation or chemical plating, the fourth metallization layer 50 is arranged on the face of the second metallization layer 30 away from the support layer 10 by a method of magnetron sputtering, evaporation or chemical plating, the first conductive copper layer 60 is arranged on the face of the third metallization layer 40 away from the first metallization layer 20 by a method of electroplating or evaporation, and the second conductive copper layer 70 is arranged on the face of the fourth metallization layer 50 away from the second metallization layer 30 by a method of electroplating or evaporation.

The porous membrane layer is a PET (polyethylene terephthalate) porous membrane layer, a PP (polypropylene) porous membrane layer, a PI (polyimide) porous membrane layer, or a PE (polyethylene) porous membrane layer. The PET porous membrane layer, the PP porous membrane layer, the PI porous membrane layer or the PE porous membrane layer is low in density, which can further reduce the weight of the composite copper foil, thereby further reducing the weight of the solid-state lithium battery while facilitating manufacture.

The fibrous membrane layer is a PET fibrous membrane layer, a PP fibrous membrane layer, a PI fibrous membrane layer, or a PE fibrous membrane layer. The PET fibrous membrane layer, the PP fibrous membrane layer, the PI fibrous membrane layer or the PE fibrous membrane layer is low in density, which can further reduce the weight of the composite copper foil, thereby further reducing the weight of the solid-state lithium battery while facilitating manufacture.

The pore of the porous membrane layer or the fibrous membrane layer has a pore size of 0.05-500 μm and a porosity of 0.1%-80%, and the numerical values can ensure that the lithium ions are capable of passing through the pore. Moreover, when the first metallization layer 20 and the second metallization layer 30 are arranged on the two faces of the support layer 10 by the method of magnetron sputtering, evaporation or chemical plating, respectively, a metal can be prevented from being filled in the pore.

Materials of the first metallization layer 20 and the second metallization layer 30 are both a combination of one or more of cobalt, aluminum, nickel, cadmium, magnesium, lithium, and manganese. and a dense isolation layer can be formed by using the combination of more metals.

Materials of the third metallization layer 40 and the fourth metallization layer 50 are both copper or a copper alloy. Materials of the first conductive copper layer 60 and the second conductive copper layer 70 are both copper. By adopting the copper or the copper alloy for the third metallization layer 40 and the fourth metallization layer 50, when the first conductive copper layer 60 is arranged on the face of the third metallization layer 40 away from the first metallization layer 20 by the method of electroplating or evaporation and the second conductive copper layer 70 is arranged on the face of the fourth metallization layer 50 away from the second metallization layer 30 by the method of electroplating or evaporation, generation speeds of the first conductive copper layer 60 and the second conductive copper layer 70 can be increased.

A thickness of the support layer 10 is 1-30 μm (micron), preferably 10 μm. Thicknesses of the first metallization layer 20 and the second metallization layer 30 are both 5-100 nm (nanometer), preferably 50 nm. Thicknesses of the third metallization layer 40 and the fourth metallization layer 50 are both 10-200 nm, preferably 100 nm. Thicknesses of the first conductive copper layer 60 and the second conductive copper layer 70 are both 500-2,000 nm, preferably 1,000 nm. By adopting such thicknesses, a total thickness of the composite copper foil of the present application is 2.03-34.6 μm and is small, which can further reduce the weight of the composite copper foil, thereby further reducing the weight of the solid-state lithium battery.

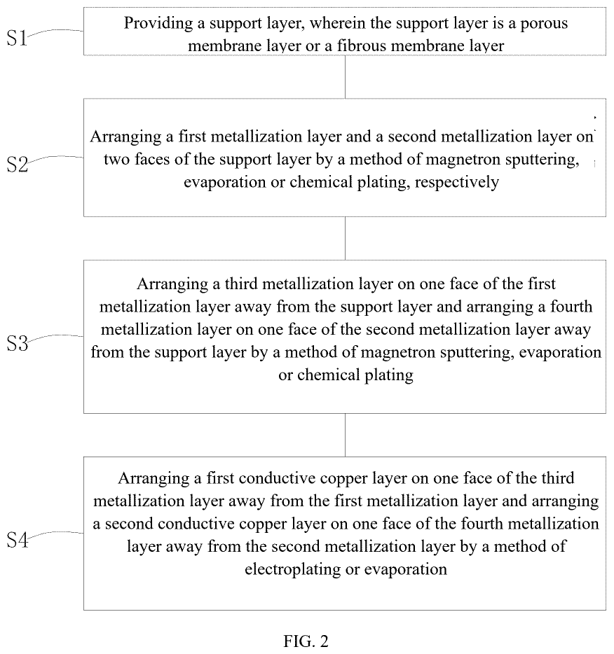

Referring to FIG. 2, the present application also provides a method for preparing composite copper foil for a solid-state lithium battery based on the above composite copper foil for the solid-state lithium battery, which includes the following steps.

S1, providing the support layer 10, wherein the width and length of the support layer 10 can be set according to actual situations; the thickness of the support layer 10 is 1-30 μm; the support layer 10 is the porous membrane layer or the fibrous membrane layer; the porous membrane layer is the PET porous membrane layer, the PP porous membrane layer, the PI porous membrane layer, or the PE porous membrane layer; the fibrous membrane layer is the PET fibrous membrane layer, the PP fibrous membrane layer, the PI fibrous membrane layer, or the PE fibrous membrane layer; and the pore of the porous membrane layer or the fibrous membrane layer has the pore size of 0.05-500 μm and the porosity of 0.1%-80%;

S2, arranging the first metallization layer 20 and the second metallization layer 30 on the two faces of the support layer 10 by the method of magnetron sputtering, evaporation or chemical plating, respectively, wherein the materials of the first metallization layer 20 and the second metallization layer 30 are both the combination of one or more of cobalt, aluminum, nickel, cadmium, magnesium, lithium, and manganese; and the thicknesses of the first metallization layer 20 and the second metallization layer 30 are both 5-100 nm;

S3, arranging the third metallization layer 40 on the face of the first metallization layer 20 away from the support layer 10 and arranging the fourth metallization layer 50 on the face of the second metallization layer 30 away from the support layer 10 by the method of magnetron sputtering, evaporation or chemical plating, wherein the materials of the third metallization layer 40 and the fourth metallization layer 50 are both the copper or the copper alloy; and the thicknesses of the third metallization layer 40 and the fourth metallization layer 50 are both 10-200 nm; and

S4, arranging the first conductive copper layer 60 on the face of the third metallization layer 40 away from the first metallization layer 20 and arranging the second conductive copper layer 70 on the face of the fourth metallization layer 50 away from the second metallization layer 30 by the method of electroplating or evaporation. The materials of the first conductive copper layer 60 and the second conductive copper layer 70 are both the copper, and the thicknesses of the first conductive copper layer 60 and the second conductive copper layer 70 are both 500-2,000 nm.

The preparation method of the present application has a simple process and convenience in manufacture, and the prepared composite copper foil has a low weight and a low cost, which can reduce the weight and manufacturing cost of the solid-state lithium battery, and meanwhile can increase the charge-discharge speed of the solid-state lithium battery, thereby greatly meeting use demands.

The above is a specific description of preferred embodiments of the present application, but the inventive creation is not limited to the embodiments. Various equivalent transformations or substitutions can also be made by technical persons familiar with the art under the premise of not departing from the spirit of the present application, and all of these equivalent transformations or substitutions fall within the scope limited by the claims of the present application.

What is claimed is:

1. A three-dimensional composite copper foil for a solid-state lithium battery, comprising a support layer, wherein
the support layer is a porous membrane layer or a fibrous membrane layer;
a first metallization layer and a second metallization layer are arranged on two faces of the support layer, respectively, a third metallization layer is arranged on one face of the first metallization layer away from the support layer, a fourth metallization layer is arranged on one face of the second metallization layer away from the support layer; and
a first conductive copper layer is arranged on one face of the third metallization layer away from the first metallization layer, and a second conductive copper layer is arranged on one face of the fourth metallization layer away from the second metallization layer.

2. The three-dimensional composite copper foil for the solid-state lithium battery according to claim 1, wherein the porous membrane layer is a polyethylene terephthalate (PET) porous membrane layer, a polypropylene (PP) porous membrane layer, a polyimide (PI) porous membrane layer, or a PE porous membrane layer.

3. The three-dimensional composite copper foil for the solid-state lithium battery according to claim 1, wherein the fibrous membrane layer is a PET fibrous membrane layer, a PP fibrous membrane layer, a PI fibrous membrane layer, or a PE fibrous membrane layer.

4. The three-dimensional composite copper foil for the solid-state lithium battery according to claim 1, wherein a pore of the porous membrane layer or the fibrous membrane layer has a pore size of 0.05-500 μm and a porosity of 0.1%-80%.

5. The three-dimensional composite copper foil for the solid-state lithium battery according to claim 1, wherein materials of the first metallization layer and the second metallization layer are both a combination of one or more of cobalt, aluminum, nickel, cadmium, magnesium, lithium, and manganese.

6. The three-dimensional composite copper foil for the solid-state lithium battery according to claim 1, wherein materials of the third metallization layer and the fourth metallization layer are both copper or a copper alloy.

7. The three-dimensional composite copper foil for the solid-state lithium battery according to claim 1, wherein a thickness of the support layer is 1-30 μm.

8. The three-dimensional composite copper foil for the solid-state lithium battery according to claim 1, wherein thicknesses of the first metallization layer and the second metallization layer are both 5-100 nm, and thicknesses of the third metallization layer and the fourth metallization layer are both 10-200 nm.

9. The three-dimensional composite copper foil for the solid-state lithium battery according to claim 1, wherein thicknesses of the first conductive copper layer and the second conductive copper layer are both 500-2,000 nm.

10. A method for preparing a three-dimensional composite copper foil for a solid-state lithium battery, comprising the following steps:
S1, providing a support layer, wherein the support layer is a porous membrane layer or a fibrous membrane layer;
S2, arranging a first metallization layer and a second metallization layer on two faces of the support layer by a method of magnetron sputtering, evaporation or chemical plating, respectively;
S3, arranging a third metallization layer on one face of the first metallization layer away from the support layer and arranging a fourth metallization layer on one face of the second metallization layer away from the support layer by a method of magnetron sputtering, evaporation or chemical plating; and
S4, arranging a first conductive copper layer on one face of the third metallization layer away from the first metallization layer and arranging a second conductive copper layer on one face of the fourth metallization layer away from the second metallization layer by a method of electroplating or evaporation.
